(19) United States
(12) Patent Application Publication
(10) Pub. No.: US 2012/0029875 A1
(43) Pub. Date: Feb. 2, 2012

(54) MONITORING UNIT FOR THE OPERATION OF CONTROL CABINET DEVICES

(75) Inventors: Martin Rossmann, Huttenberg-Reiskirchen (DE); Daniel Rosenthal, Siegen (DE); Ulrich Prinz, Weilburg (DE)

(73) Assignee: Rittal GmbH & Co. KG, Herborn (DE)

(21) Appl. No.: 12/735,526

(22) PCT Filed: Feb. 26, 2009
(86) PCT No.: PCT/EP2009/001350

§ 371 Date: Jul. 23, 2010

(30) Foreign Application Priority Data
Feb. 29, 2008 (DE) 10 2008 012 097.9

(51) Int. Cl. G06F 15/00

(52) U.S. Cl. 702/184; 702/183

(57) ABSTRACT

A monitoring unit for the operation of control cabinet devices, particularly a climate control device, having a detection unit for operating state data of the control cabinet devices, a monitoring unit including an analysis unit, and a display unit for displaying informational data on the control cabinet devices for a verifying person. A reliable, clearly laid-out detection of operating states is achieved because the analysis unit has a collection device for different physical operating state data over a previous time duration influencing the function of the control cabinet device, and a calculating device for the operating state data, and that informational data, which is derived from the operating state data while calculating by way of the calculating device, is provided to the display device for the verifying person before any malfunction occurs.

### BACKGROUND OF THE INVENTION

1. Field of the Invention

This invention relates to a monitoring unit for the operation of control cabinet devices, in particular a climate control unit, having a detection unit for operating state data of the control cabinet devices, a monitoring device with an evaluation unit, and a display unit for providing a testing specialist with a display of informational data about the control cabinet devices.

2. Discussion of Related Art

A monitoring unit for a control cabinet climate control unit is disclosed in German Patent Reference DE 196 09 651 C2. In this known monitoring unit, operating state data of a climate control unit are automatically monitored by a central control unit as a function of sensor signals and are controlled in an optimized fashion as a function of the sensor signals and/or adjustable or programmable defaults, in coordination with different cooling requirements or a production of noise. Depending on the surroundings, the use of the control cabinet adapted to said surroundings, and the control concept, components of the climate control units can be exposed to greater or lesser loads, which can limit the service life or reliability of the system as a whole and then the optimization is carried out on the basis of these limitations so that the control is no longer able to achieve the optimal state.

German Patent Reference DE 196 09 689 B4 has disclosed a unit for monitoring and controlling a control cabinet, having a central control unit for monitoring, controlling, and/or regulating installed units and/or add-on units. Here, operating state data are recorded by a detection unit in the central control unit and are evaluated and displayed so that a testing specialist can detect malfunctions and eliminate them. It is also possible to read out and change adjustment parameters, such as by a PC interface output. To be able to perform service procedures, the service personnel are specially trained in correctly eliminating malfunctions. In addition, malfunctions can lead to a device failure for the user, even of devices installed by the user.

German Patent Reference DE 10 2006 011 127 A1 has disclosed a control cabinet monitoring unit with sensors that are brought into a wireless data transmission connection with a base station, that can be flexibly positioned in the control cabinet arrangement, and that can be associated with control cabinet devices or their components. With signaling units, malfunctions or operating states can be displayed for a testing specialist. Although these measures achieve an improved malfunction detection, error states cannot be completely avoided.

### SUMMARY OF THE INVENTION

One object of this invention is to provide a monitoring unit for operation of control cabinet devices that is able to achieve an increased reliability.

This object is attained by a monitoring unit having characteristics described in this specification and in the claims. In this case, the evaluation unit has a collecting unit for various physical operating state data over a preceding time interval, which data influence the function of the control cabinet device, and an offsetting unit for the operating state data and the display unit has informational data for the testing specialist even before the occurrence of a malfunction, which data are derived based on the operating state data through offsetting by the offsetting unit.

The collected operating state data of different types over a preceding time interval and the offsetting of them yield highly reliable informational data that are communicated to the testing specialist via the display unit and can be accessed by the testing specialist at any time, such as via a mobile, portable hand-held unit. Based on the prior history, the testing specialist is shown anticipatory prognosis values and if need be, given instructions for service procedures.

An increased reliability is supported if the operating state data include function data relating to the working procedures of the control cabinet and environmental data relating to external influence factors. The inclusion of environmental data in addition to function data relating to the actual working procedures of the control cabinet device achieves an increased precision of the state analysis of the control cabinet device and thus of the informational data for the testing specialist, such as prognosis information or servicing instructions.

In addition, the provisions that the preceding time interval extends from a current time back to the time of the initial startup of the control cabinet device or of a relevant device component or back to a preset or presettable time are advantageous for a precise offsetting and evaluation.

In one embodiment of the monitoring unit of this invention, the evaluation unit has a comparison unit that ascertains if at least one predetermined change of an operating state data type has occurred in comparison to a last stored value or a preset value of this operating state data type and the values of the relevant operating state data type can be stored in the collecting unit together with the associated time when the predetermined change is exceeded or ascertained.

In this connection, in one embodiment the evaluation unit has the change in the operating state data type ascertained at preset time intervals or by a query at the request of the testing specialist.

If the function data include oscillations caused by the control cabinet device, noise, heat, smoke, performance parameters, a malfunction, running times, and/or maintenance work and if the environmental data include ambient temperatures, external oscillations, moisture, and/or smoke then reliable informational data can be derived.

To provide the testing specialist with user guidance and permit a rapid, clear identification of states as well as steps to be taken if need be, the offsetting unit can be programmed to calculate a graduated service requirement level on the basis of the operating state data and the display unit can optically and/or acoustically signal the service requirement level in different urgency stages.

Various embodiments for the offsetting of the operating state data and derivation of the informational data include the offsetting unit being programmed for offsetting in accordance with preset algorithms or in a self-teaching fashion.

The provision that the monitoring unit has sensors situated on the control cabinet device and/or in its vicinity for detecting operating state data, with a wireless or hard-wired data transmission interface permits reliable detection of the operating state data.

A design that is advantageous from a control standpoint is achieved if the detection unit and the display unit have interfaces for wireless data transmission via radio, preferably with a transmission with chirp signals, which yield an increased transmission security, for example in the frequency range around 2.4 GHz.

### BRIEF DESCRIPTION OF THE DRAWINGS

This invention is explained in view of exemplary embodiments shown in the drawings, wherein:

FIG. 1 shows a monitoring unit for the operation of control cabinet devices with a plurality of control cabinets and one monitoring device with a connection for data transmission; and

FIG. 2 shows a graph for the evaluation of operating states of the control cabinet devices.

### DETAILED DESCRIPTION OF THE INVENTION

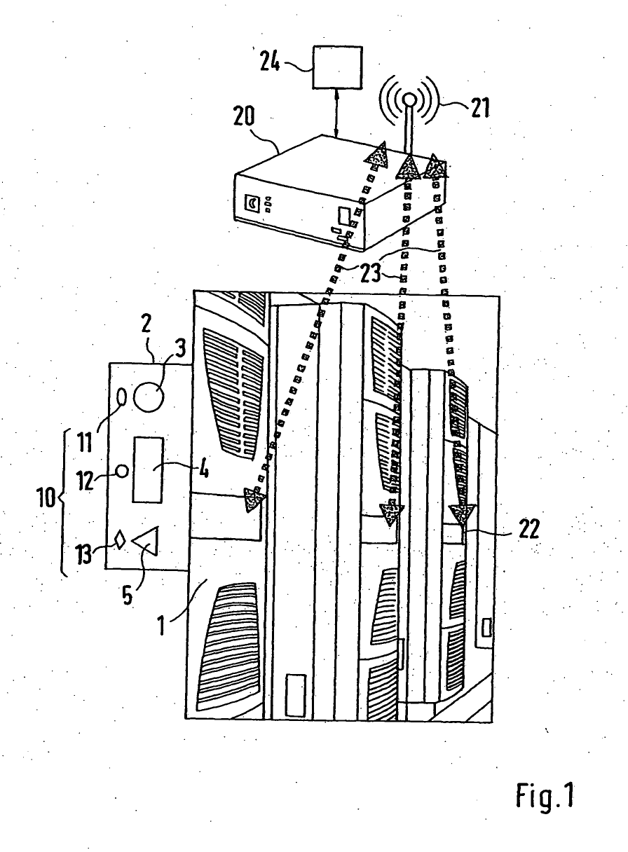

FIG. 1 shows a control cabinet arrangement with a plurality of control cabinets 1 and control cabinet devices contained therein, in particular climate control units 2 having a plurality of device components, namely at least one fan 3, a compressor 4, and valves 5, among other elements.

The at least one control cabinet contains a detection unit with sensors 11, 12, 13 of a sensor unit 10 and/or with a detector device such as a time measuring device, a current monitoring device, a performance monitoring device, or the like for operating state data of the control cabinet device or its device components. The sensors advantageously have interfaces for wireless data transmission, but can also be at least partially embodied for hard-wired data transmission, for example to a relay point, via which the sensor data are then transmitted, for example wirelessly, to a shared monitoring device 20 of the monitoring unit. The operating state data recorded by the detection unit are preferably transmitted via a wireless data transmission interface 22 to the sensors, the control cabinet device 2, such as a climate control unit or the control cabinet 1, or also a relay that is separate from it, via the transmission path 23 and an additional wireless data transmission interface 21 of the monitoring device 20. There is also a display unit 24 with a visual display and/or an acoustical indicator that is integrated into the monitoring device or is separate from it and has a connection to it for data transmission. There is thus the possibility of a remote maintenance, such as with the integration into a data network or bus system. The display unit 24 can, for example, be embodied as a hand-held display unit with a processor unit and can be equipped for wireless data transmission between itself and the monitoring device 20, thus providing a testing specialist with an easy-to-use, mobile query station equipped with a display.

The evaluation unit situated in the control cabinet device 2, the control cabinet 1, or the control cabinet arrangement and/or the monitoring device 20 has a collecting unit for operating state data, which influence the function of the control cabinet device and are interrelated to it and are relevant to various physical states of the control cabinet device, for example the climate control unit 2 and its device components such as a fan 3, a compressor 4, valves 5, and the like. The operating state data in this case include function data relevant to the actual function of the control cabinet device 2, such as its actual mode of operation, and/or environmental data relevant to external influence factors. For example, the function data also include maintenance procedures performed, oscillations occurring in the control cabinet device, noise, heat, smoke, performance parameters, malfunctions, running times, or the like and the environmental data include, for example, ambient temperatures, oscillations or vibrations due to external jolting, moisture, smoke, or the effects of human influences such as unauthorized access or violent impacts, for which purpose corresponding sensors, such as even image recorders or acoustic sensors, are provided in addition to temperature sensors, smoke detectors, moisture sensors, vibration sensors, and/or access sensors.

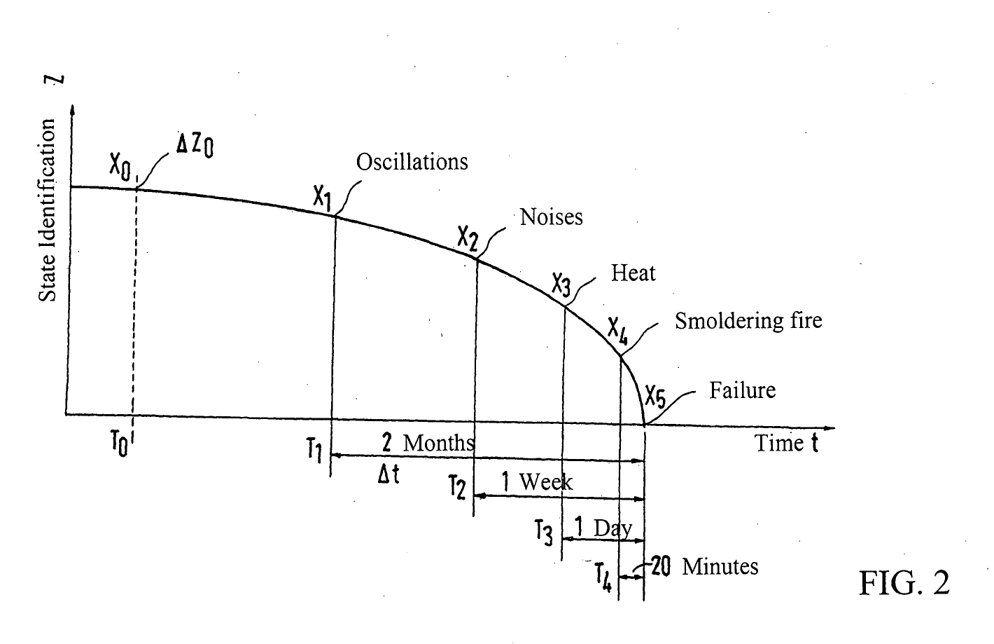

The collecting unit records different physical operating state data of this kind over a preceding time interval and supplies them to an offsetting unit of the evaluation unit, which is positioned, for example, in the monitoring device 20, in order to derive informational data through offsetting based on the operating state data and to supply these informational data to a display for a testing specialist. The preceding time interval in this case can extend back, for example, to the installation of the relevant control cabinet device or of a monitored component 3, 4, 5, back to a past maintenance time, or back to a first occurrence of an anomalous event in which there is a deviation from a predetermined operating state ΔZ_{V}. For example, as shown in FIG. 2, such a first deviation ΔZ₀ first occurs at a time T₀, yielding a relevant point X₀ of the state Z as a function of time t. Correspondingly, the collecting unit collects other operating state data at times T₀, T₁, T₂, T₃, T₄ at time intervals Δt preset in the evaluation unit or upon occurrence of a preset deviation ΔZ and/or when requested by service personnel, thus yielding other state points X₁, X₂, X₃, X₄, X₅. The collected operating state data of various types are offset in accordance with a preset program or also in accordance with a self-teaching rule, in order to derive the most reliable possible informational data that provide information about the operating state of the control cabinet device such as the climate control unit 2 and/or a relevant device component 3, 4, 5. For example, the detection unit detects conspicuous oscillations at point X₁, an increase or change in noise at point X₂, an increase in heat at point X₃, smoke or a smoldering fire at point X₄, and a significant malfunction or device failure at point X₅.

A coupling of the monitoring unit, in particular the monitoring device 20, to operator-installed units such as servers or the like, such as by a switcher unit with controlled switches that advantageously permits the operator units to be integrated into the monitoring unit and permits the testing specialist to display and evaluate corresponding state data.

The informational data are advantageously categorized by urgency stages and are identified more or less conspicuously according to their urgency so that in response to a corresponding query, the testing specialist receives a quick overview by the optical and/or acoustical display. For example, noncritical operating states can be displayed by stored informational data displayed in green, more critical information can be displayed in yellow, and urgent informational data can be displayed in red, with simultaneous indication of a relevant critical operating state type such as anomalous noise production, unusual structure-borne noise, heat, smoke, or the occurrence of a malfunction, or possibly combinations of these parameters. In addition, the testing specialist is instructed to carry out an appropriate service procedure and/or is informed of the necessity or suitability of such a procedure.

For example, when a testing specialist walks through a room containing a plurality of control cabinets and associated control cabinet devices, the informational data provide a quick, clear overview of the respective operating states, such as by a portable hand-held device with a display unit, so that it is even possible to initiate service procedures early. For example, even when correcting a malfunction or performing a routine replacement of a device component, service personnel can inquire as to the operating state of other control cabinet devices or device components 3, 4, 5 and can take anticipatory steps to prevent an impending failure or make appointments for upcoming service procedures. This achieves an anticipatory maintenance with increased operational reliability of the monitored control cabinet devices, in particular climate control units 2, thus also protecting user devices from malfunction.

For queries and user guidance, the sensors, for example, can identify the control cabinet devices and device components by a unique identifier. A wireless transmission via radio is embodied so that it does not malfunction when exposed to electromagnetic interference fields and has a special transmission technology using chirp signals in the frequency range around approximately 2.4 GHz. This achieves a clear, reliable data transmission for the detection and display of operating data.

1. A monitoring unit for an operation of control cabinet devices, in particular a climate control unit (2), including a detection unit for operating state data of the control cabinet devices, a monitoring device (20) with an evaluation unit, and a display unit (24) providing a testing specialist with a display of informational data about the control cabinet devices, wherein the evaluation unit has a collecting unit for various physical operating state data over a preceding time interval which influence the function of the control cabinet device, and an offsetting unit for the operating state data and the display unit (24) having informational data for the testing specialist even before an occurrence of a malfunction which are derived based on the operating state data through offsetting by the offsetting unit.

2. The monitoring unit as recited in claim 1, wherein the operating state data include function data relating to work procedures of the control cabinet device and environmental data relating to external influence factors.

3. The monitoring unit as recited in claim 2, wherein the preceding time interval extends from a current time back to an initial startup time of the control cabinet device or of a relevant device component.

4. The monitoring unit as recited in claim 3, wherein the evaluation unit has a comparison unit that ascertains if at least one predetermined change (ΔZ_{V}) of a particular operating state data type has occurred in comparison to a last stored value or a preset value of the operating state data type and values of the relevant operating state data type are storable in the collecting unit together with an associated time when the predetermined change (ΔZ_{V}) is exceeded or ascertained.

5. The monitoring unit as recited in claim 4, wherein the evaluation unit has a change (ΔZ₀) in the operating state data type ascertained at preset time intervals (Δt) or by a query at a request of a testing specialist.

6. The monitoring unit as recited in claim 5, wherein the function data include oscillations caused by the control cabinet device, a noise, a heat, a smoke, performance parameters, a malfunction, running times, and/or a maintenance work and the environmental data include ambient temperatures, external oscillations, a moisture, and/or the smoke.

7. The monitoring unit as recited in claim 6, wherein the offsetting unit is programmed to calculate a graduated service requirement level on a basis of the operating state data and the display unit is able to optically and/or acoustically signal the service requirement level in different urgency stages.

8. The monitoring unit as recited in claim 7, wherein the offsetting unit is programmed for offsetting in accordance with preset algorithms or in a self-teaching fashion.

9. The monitoring unit as recited in claim 8, wherein the monitoring unit has sensors positioned on the control cabinet device and/or in a vicinity for detecting operating state data, with a wireless or a hard-wired data transmission interface.

10. The monitoring unit as recited in claim 9, wherein the detection unit and the display unit (24) have interfaces for wireless data transmission via a radio.

11. The monitoring unit as recited in claim 1, wherein the preceding time interval extends from a current time back to an initial startup time of the control cabinet device or of a relevant device component.

12. The monitoring unit as recited in claim 1, wherein the evaluation unit has a comparison unit that ascertains if at least one predetermined change (ΔZ_{V}) of a particular operating state data type has occurred in comparison to a last stored value or a preset value of the operating state data type and values of the relevant operating state data type are storable in the collecting unit together with an associated time when the predetermined change (ΔZ_{V}) is exceeded or ascertained.

13. The monitoring unit as recited in claim 12, wherein the evaluation unit has a change (ΔZ₀) in the operating state data type ascertained at preset time intervals (Δt) or by a query at a request of a testing specialist.

14. The monitoring unit as recited in claim 2, wherein the function data include oscillations caused by the control cabinet device, a noise, a heat, a smoke, performance parameters, a malfunction, running times, and/or a maintenance work and the environmental data include ambient temperatures, external oscillations, a moisture, and/or the smoke.

15. The monitoring unit as recited in claim 1, wherein the offsetting unit is programmed to calculate a graduated service requirement level on a basis of the operating state data and the display unit is able to optically and/or acoustically signal the service requirement level in different urgency stages.

16. The monitoring unit as recited in claim 1, wherein the offsetting unit is programmed for offsetting in accordance with preset algorithms or in a self-teaching fashion.

17. The monitoring unit as recited in claim 1, wherein the monitoring unit has sensors positioned on the control cabinet device and/or in a vicinity for detecting operating state data, with a wireless or a hard-wired data transmission interface.

18. The monitoring unit as recited in claim 1, wherein the detection unit and the display unit (24) have interfaces for wireless data transmission via a radio.
